(19) United States
(12) Patent Application Publication
(10) Pub. No.: US 2020/0053969 A1
(43) Pub. Date: Feb. 20, 2020

(54) ELEMENT FOR CULTIVATING AT LEAST ONE PLANT AND METHOD FOR PRODUCING THE ELEMENT

(71) Applicant: VERITABLE, LYAS (FR)

(72) Inventors: Nicolas GEHIN, Caluire-et-Cuire (FR); Chloé VERNEUIL, Caluire-et-Cuire (FR)

(21) Appl. No.: 16/486,707

(22) PCT Filed: Feb. 9, 2018
(86) PCT No.: PCT/FR2018/050318

§ 371 Date: Aug. 16, 2019

(30) Foreign Application Priority Data
Feb. 17, 2017 (FR) 17/51274

(51) Int. Cl. A01G 31/02; A01G 24/15; A01G 24/13

(52) U.S. Cl. CPC A01G 31/02; A01G 24/13; A01G 24/15

(57) ABSTRACT

The element is intended to be placed in a receptacle for the cultivation of at least one plant, and includes:

a substantially solid body including a substrate adapted to enable said plant to develop;

at least one seed of said plant disposed on the body in at least one seed receiving area;

a layer for holding the seed(s) in said receiving area, comprising a dried mineral powder.

The holding layer results from drying a deposition of a holding composition including a mineral powder suspended in water.

### CROSS REFERENCE TO RELATED APPLICATIONS

This application is a National Stage of PCT Application No. PCT/FR2018/050318 filed on Feb. 9, 2018, which claims priority to French Patent Application No. 17/51274 filed on Feb. 17, 2017, the contents each of which are incorporated herein by reference thereto.

### TECHNICAL FIELD

The present invention concerns an element intended to be placed in a receptacle for the cultivation of at least one plant. The invention also concerns a system for cultivating at least one plant comprising such an element, and a method for making such an element.

### BACKGROUND

There is a growing demand for indoor potager gardens which allow cultivating fruits, vegetables, and aromatic herbs at home, all year round, in a simple manner.

Conventionally, such a potager garden is a plant cultivation system which comprises a tank containing water, as well as receptacles placed in the tank and designed to enable the rise of water by capillarity. Each of the receptacles receives an element comprising a body including a substrate, and at least one seed disposed on the body.

The elements consist of consumables that the user buys, uses and then replaces at his/her convenience. It is imperative that the seeds are well held on the body during the transport and the storage of the element so that they remain present, of course, but also so that their positioning on the substrate remains unchanged. Indeed, this positioning is generally predetermined to allow a satisfactory seed germination. Thus, it is known to provide a device for holding the seed(s) in the receiving zone.

A first known solution consists in providing a lid covering the seed(s), the lid having a gluing portion to be affixed on the body of the element, and a non-gluing portion opposite the seeds. The user just has to remove the lid before placing the element in the receptacle. This solution therefore requires an additional operation to be performed by the user and generates waste.

According to a second known solution, the seed(s) is/are deposited in a recessed housing formed in the body, and a substrate is deposited over the seed(s), by filling the housing. Herein again, a gluing lid may be provided, as previously described. Therefore, the same drawbacks as those mentioned above are encountered.

A third known solution consists in depositing a drop of a composition containing water and food glue on the seed(s). The seeds are thus glued on the body, which ensures holding thereof. Nonetheless, this solution poses several problems. In particular, it does not ensure a sufficient holding of large-sized seeds, and does not allow a satisfactory management of the moisture content in the vicinity of the seed Furthermore, while the glue ensures holding of the seeds, in any case of small-sized seeds, however, it offers very little protection against external aggression. Moreover, the use of food glue may confer an unnatural appearance likely to discourage the user.

### BRIEF SUMMARY

The invention aims at providing an element in which the seeds are held in a satisfactory manner, and which solves all or part of the aforementioned problems.

For this purpose, and according to a first aspect, the invention concerns an element intended to be placed in a receptacle for the cultivation of at least one plant, the element comprising:
a substantially solid body including a substrate adapted to enable said plant to develop;
at least one seed of said plant disposed on the body in at least one seed receiving area;
a layer for holding the seed(s) in said receiving area;

in which said holding layer comprises a dried mineral powder forming a deposition configured to securely fix the seed on the body.

The term «substantially solid » means that the element has a defined shape, and that when it is manipulated during its normal use (transport, setup in the cultivation system), it maintains this shape. This does not exclude a local deformation of the element—for example the creation of a notch by a user's fingernail. Of course, a substantial deformation of the element is still possible under efforts greater than those exerted for the intended use of the element.

Moreover, it is specified that the fact that the seed is disposed on the body means that the seed is not pressed into the body itself, but deposited on a surface of the body of the element. This does not exclude the seed being placed in a cavity of the body which is open to the outside of the body, the seed then remaining visible and accessible from outside of the body.

The invention provides that the holding layer comprises a dried mineral powder, that is to say a mineral powder which, initially wet or scattered in an aqueous solution, has dried. In other words, there has been a water removal, for example by simple air drying and/or by water absorption in the body, typically in the substrate. Thus, on the ready-to-use element, the holding layer is dry, that is to say substantially not impregnated with liquid.

The presence of a holding layer comprising a dried mineral powder has many advantages.

In addition to the simplicity of manufacture, this solution ensures a high reliability of the holding of seeds in the body, whether these consist of small or large seeds, as well as a significant resistance to shocks and vibrations.

The effectiveness of the solution according to the invention arises at the time of transport, since the dried mineral powder allows securely fixing the seed on the body, but also at the time of storage and germination. Indeed, the use of a mineral powder allows for a faster drying than is the case with a food glue, which results in reducing the exposure time of the seed to moisture. The results is a better germination rate after storage since the seed has not stayed for a long time in a humid environment, which could have had the effect of triggering the germination process and compromising the quality of the seed later on. Furthermore, at the time of use of the element, the mineral powder supplies essential nutrients for the development of the plant.

Another significant advantage of the invention is to provide an element having a natural appearance, which is generally an important factor for the user of such cultivation systems.

According to a possible embodiment, the holding layer covers and encompasses the seed(s) in the receiving area. The fact of coating the seeds —as opposed to a simple film deposition as is the case with food glue—allows protecting the seed(s) from external aggressions, but also bringing more significant moisture content around the seed at the time of use of the element.

It can be provided that the receiving area comprises a recessed housing formed in the body and upwardly open, in the position of use of the element, the seed(s) being disposed at the bottom of the housing. In this case, the holding layer may at least partially cover the internal surface of the housing, and not only the seed(s). Thus, an even better protection of the seed is obtained.

The mineral powder may be a natural mineral powder. It may for example contain silicates.

According to a possible embodiment, the mineral powder is selected from the group including: clay, talc, pumice stone.

The mineral powder may have a grain-size comprised between 5 and 200 μm, preferably between 20 and 100 μm, more preferably between 30 and 60 μm, for example in the range of 45 μm.

Furthermore, the holding layer may comprise at least one compound selected from: a fungicide, a germination promoting agent.

According to a second aspect, the invention concerns a system for cultivating at least one plant, comprising:
a tank including a bottom, a peripheral wall and an upper opening, said tank being intended to contain water;
a tray disposed at the level of the upper opening of the tank, including at least one aperture;
at least one mast supporting at least one light source;
at least one element as previously described;
at least one receptacle comprising a bottom and a peripheral wall, the receptacle receiving said element and being placed in the tank and received in an aperture of the tray.

According to a third aspect, the invention concerns a method for making an element intended to be placed in a receptacle for the cultivation of at least one plant, the element comprising a substantially solid body including a substrate adapted to enable said plant to develop, and at least one seed of said plant disposed on the body in a seed receiving area, the method comprising the deposition of a holding composition on the seed(s) previously disposed on the body, in order to hold the seed(s) in said receiving area. According to the invention, the method comprises the deposition of a holding composition which includes a mineral powder suspended in water.

Concretely, the substrate contained in the body or forming the body quickly absorbs the liquid, leaving a clay deposition (and possible additives) on the surface of the body, this deposition covering and encompassing the seed(s). The drying of the substrate then allows dehydrating the clay layer and securely holding the seed(s) at the desired location. In practice, it is possible to proceed with a natural drying, by keeping the element in a standard indoor environment (conventional humidity and temperature) for a drying phase of about twelve hours, before the final conditioning.

In addition to the advantages obtained on the ready-to-use element, as previously exposed, the method according to the invention also has advantages, in particular a great simplicity of implementation. Moreover, the method according to the invention allows adapting the composition easily depending on the seeds, in particular the amount of mineral powder depending on the size of the seeds, and/or the possible additives according to the desired properties (germination time, protection against diseases, fungi, etc.).

The mineral powder may consist of a natural mineral powder which may for example contain silicates. The mineral powder may be selected from the group including: clay, talc, pumice stone.

According to a possible embodiment, the holding composition comprises from 15 to 25 weight %, for example in the range of 20 weight %, of mineral powder. This mineral powder may have a grain-size comprised between 5 and 200 μm, preferably between 20 and 100 μm, more preferably between 30 and 60 μm, for example in the range of 45 μm. It may in particular consist of a clay powder having a grain-size close to 45 μm.

The method may include mixing the holding composition prior to its deposition over the seed(s). Such a mixing aiming at preventing the mineral powder from depositing or blending, and at homogenizing the holding composition, it is preferably carried out immediately before the deposition of the holding composition over the seed(s).

The deposition of the holding composition may be carried out by means of a pump system. Alternatively, it may be performed manually, for example with a pipette.

Furthermore, the holding composition may comprise at least one compound selected from: a fungicide, a germination promoting agent.

When the receiving area comprises a recessed housing formed in the body and upwardly open, in the position of use of the element, the seed(s) being disposed at the bottom of the housing, the method may comprise the deposition of a holding composition in a sufficient amount to substantially fill the housing.

### BRIEF DESCRIPTION OF THE DRAWINGS

A possible embodiment of the invention is now described, as a non-limiting example, with reference to the appended figures:

FIG. 1 is an exploded perspective view of a system for cultivating at least one plant according to the invention;

FIG. 2 is a perspective view of an element according to the invention, ready to be placed in a receptacle of the system;

FIG. 3 is a schematic view of an element illustrating the deposition of seeds and a composition for holding the seeds on the element;

FIGS. 4a to 4d schematically illustrate steps of the method for depositing a holding composition on an element;

FIG. 5 is a schematic representation of a possible embodiment of the method according to the invention.

### DETAILED DESCRIPTION

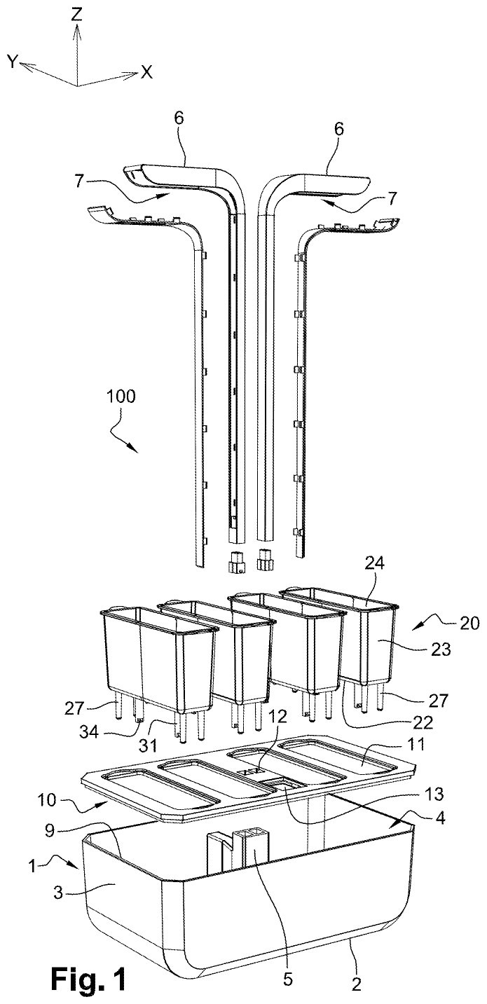

FIG. 1 represents a system 100 for cultivating at least one plant, which is particularly adapted to enable cultivation inside a building.

The system 100 comprises a tank 1 which includes a bottom 2, generally planar, a peripheral wall 3 and an upper opening 4. The tank 1 is for example substantially parallelepipedal. A sealed receiving space intended to contain water or another appropriate liquid is thus defined inside the tank 1, to enable the cultivation of the plants.

The vertical direction Z, orthogonal to the bottom 2 when the tank 1 is placed on a support such as a table or a work plane, is defined. The horizontal direction X, parallel to the long sides of the tank 1, and the horizontal direction Y, parallel to the short sides of the tank 1, are also defined. In the following description, the different parts or components will be described in the position that they occupy in operation.

A support 5 projects from the bottom 2 of the tank 1, according to Z and upwards. One or several mast(s) 6 (two masts in the represented example) are fitted onto or into the support 5. Each mast 6 carries a plurality of light sources 7, for example light-emitting diodes (LEDs), providing the luminous energy necessary for the growth of the plants.

The system 100 further comprises a tray 10 disposed at the level of the upper opening 4 of the tank. The tray 10 may for example be removably fastened to the upper edge 9 of the peripheral wall 3 of the tank 1.

The tray 10 comprises at least one aperture 11 intended to receive a receptacle 20 containing the plants, the aperture 11 preferably having a shape complementary to that of the receptacle 20. In the embodiment represented as example, the tray 10 comprises four apertures 11. Furthermore, the apertures 11 are substantially rectangular, with the long side oriented parallel to Y, this being not limiting. The tray 10 further comprises holes 12 for the passage of the masts 6, and a hole 13 enabling the user to pour water at the bottom of the tank 1 without having to remove the tray 10.

A receptacle 20 is intended to be placed in the tank 1, in each of the apertures 11 of the tray 10. The receptacle 20 may be made of plastic material, for example by molding. The receptacle 20 comprises a bottom 22 and a peripheral wall 23, and has an upper opening 24. In this instance, it is substantially parallelepipedal, this being not limiting.

The receptacle 20 may be provided with legs 27 extending downwardly from the bottom 22, to enable bearing on the bottom 2 of the tank 1 and holding away from the bottom 2 of the tank 1. It may be provided that in the mounted position, the receptacle 20 is substantially flush with the tray 10.

Furthermore, the receptacle 20 comprises a chimney 31 which extends substantially vertically downwards from the bottom 22, over a height smaller than or equal to that of the legs 27, and which opens into the bottom 22. In the chimney 31, a capillary liquid transport member, such as a wick, is disposed. In order that this member be in contact, in the lower portion thereof, with the water present in the tank 1, it is possible for the member to extend beyond the lower end of the chimney 31, and/or that the chimney 31 includes an orifice 34, at the lower portion thereof, through which water can penetrate in order to reach the member.

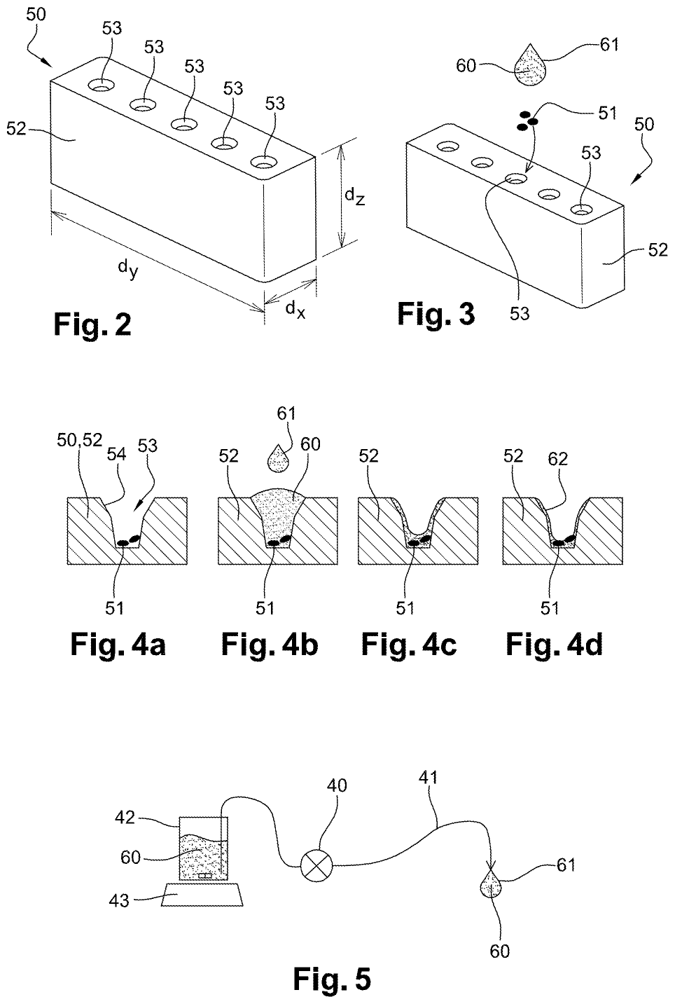

Moreover, the system 100 comprises at least one element 50 which is intended to be placed in a receptacle 20, as schematically illustrated in FIG. 2. The element 50, which constitutes a ready-to-use refill, includes a substantially solid body 52, whose dimensions enable it to be inserted into a receptacle 20. The element 50 may thus generally have a parallelepiped shape. As example, its dimensions may be as follows: dx=140 mm, dy=40 mm, d=80 mm.

The body 52 includes a substrate adapted to enable the plant to develop. The substrate may for example include one or several cellulosic material(s), in the form of fibers and/or powder, such as coconut fibers, bamboo fibers, coconut powder. The body 52 may also comprise a fertilizer.

The element 50 further comprises at least one seed 51, and in practice several seeds 51 (see FIG. 3). The seed(s) 51 is/are disposed on the body 52 in at least one seed receiving area. For example, as illustrated in FIGS. 2 and 3, the receiving area comprises a recessed housing 53 formed in the body 52 and upwardly open, in the use position of the element 50. The seed(s) 51 is/are then disposed at the bottom of the housing 53, as shown in particular in FIG. 4a. In the embodiment represented as example, the body 51 of the element 50 includes five housings 53 aligned in the direction Y, and regularly spaced, this being not limiting.

In order to ensure holding of the seeds 51 on the body 52 of the element 50, in the position which has been predetermined to ensure efficient germination and growth, it is intended to make a layer for holding the seed(s) in the seed receiving area 51

Next, the description will be performed in the case where the seed receiving area is formed by the housing 53.

As illustrated in FIGS. 3 and 4a, one or several seed(s) 51 is/are placed at the bottom of each housing 53. Then, a holding composition 60 is deposited over the seed(s) 51.

According to the invention, the holding composition 60 comprises a mineral powder suspended in water.

For example, this mineral powder may consist of clay, preferably relatively fine, for example having a grain-size comprised between 30 and 60 μm, in the range of 45 μm. The holding composition 60 may comprise from 15 to 25 weight %, for example in the range of 20 weight %, of clay. Other mineral powders may be used, for example talc or pumice stone. These choices are advantageous in that they provide natural solutions, in contrast with food glue.

The holding composition 60 may further comprise a fungicide and/or a germination promoting agent.

The holding composition 60 is deposited in an appropriate amount to allow for a satisfactory holding of the seeds 51. Concretely, one or several drop(s) 61 of the holding composition 60 may be deposited, for example to substantially fill the housing 53, as illustrated in FIG. 4b.

The deposition may be performed manually. Alternatively, it may be performed via a mechanical, electrical and/or hydraulic system, by means of a pump 40 and hoses 41, as illustrated in FIG. 5.

In order to ensure a proper homogeneity of the holding composition 60 which will be deposited over the seeds 51, this holding composition 60 is preferably continuously mixed before its deposition, thereby keeping the clay powder in suspension. Obtaining a homogeneous liquid is particularly easy as the used clay is in the form of a very fine powder. In FIG. 5, as example, the holding composition 60 intended to be sucked by the pump 40 is placed in a receptacle 42 on a magnetic stirring system 43. Nonetheless, other solutions are still possible (mechanical mixing, etc.).

The water contained in the holding composition 60 deposited in the housing 53 will then be absorbed by the body 52, typically by the substrate, and may also be partially evaporated, as shown in FIG. 4c, then in FIG. 4d.

Tests have shown that the period during which the mineral powder remains very wet is about 1 minute (this corresponds to the time of absorption of water by the substrate). This time is relatively short, compared to the solution consisting in depositing food glue where the period of moisture can be close to 10 minutes. The method according to the invention is thus more advantageous because as the seed is less exposed to moisture before the use of the element 50, it is not altered and has an enhanced germination capacity after storage. Then comes the evaporative drying phase.

The mineral powder—herein the dried clay—is then deposited on the surface of the body 52 to form a holding layer 62, shown in FIG. 4d. The holding layer 62, which thus comprises the dried mineral powder, covers and encompasses the seed(s) 51 in the receiving area, formed herein by the housing 53. The holding layer 62 may also at least partially cover the internal surface 54 of the housing 53.

As shown by comparing FIGS. 4b and 4d, the holding layer 62 has a much smaller volume than the holding composition drop(s) that have been deposited in the housing 53. In particular, the holding layer 62, which is therefore dry, does not fill the entire housing 53. As example, the thickness of the holding layer 62 may be comprised between 0.2 and 2 mm depending on the clay concentration in the holding composition 60, and the amount of deposited holding composition 60.

The element 50 thus made, containing the seeds 51 securely fixed on the body 50 thanks to the holding layer 62, can be transported and stored without risk for the seeds 51, until use by the consumer.

Concretely, the user has only to place an element 50 in a receptacle 20. By capillarity, the substrate will be rehydrated, and bring moisture to the holding layer 62 and the seeds 51. Compared to the solutions of the prior art, and in particular to the use of food glue, the use of a mineral powder is advantageous because it allows, in operation, forming a wetter environment for the seed 51, which is conducive to its development.

Another significant advantage of the invention lies in the fact that the holding composition 60 can be easily adapted to the different types of seeds 51, in order to ensure an appropriate holding on the body 50 and a satisfactory protection.

Thus, on the one hand, the holding composition 60 can be adapted to the size of the seeds 51. Indeed, there are small-sized seeds, generally spherical or having a substantially rounded shape, which can be easily fixed. But there are also larger seeds, such as tomato and pepper seeds (quite-flat disk shaped) or chive seeds (striated half-moon shaped), as well as coated seeds, which are heavy and generally spherical with a diameter ranging from 2 to 5 mm. These larger seeds are very difficult to hold on the body with the solutions of the prior art. The invention allows, on the contrary, ensuring an effective holding of these seeds, thanks to the use of dried mineral powder. In addition, by increasing the concentration of mineral powder in the holding composition (up to about 30%, for example), a thicker dried powder deposition is obtained, and this thicker holding layer allows for a better holding of the large seeds.

On the other hand, the holding composition 60 can be adapted to the nature of the seeds, the substrate and/or the environmental conditions, in particular, by the presence of additives selected to improve the germination time, protect against diseases or fungi, etc.

Thus, the invention brings a decisive improvement to the prior art, by providing an element which can be transported, stored and used without risk of loss or alteration of the seeds.

Of course, the invention is not limited to the embodiment described hereinabove as example, but it comprises all technical equivalents and variants of the described means as well as the combinations thereof.

1. An element intended to be placed in a receptacle for the cultivation of at least one plant, the element comprising:
a substantially solid body including a substrate adapted to enable said plant to develop;
at least one seed of said plant disposed on the body in at least one seed receiving area;
a layer for holding the seed(s) in said receiving area;
characterized in that said holding layer comprises a dried mineral powder forming a deposition configured to securely fix the seed on the body.

2. The element according to claim 1, wherein the holding layer covers and encompasses the seed(s) in the receiving area.

3. The element according to claim 1, wherein the receiving area comprises a recessed housing formed in the body and upwardly open, in the position of use of the element, the seed(s) being disposed at the bottom of the housing.

4. The element according to claim 3, wherein the holding layer at least partly covers the internal surface of the housing.

5. The element according to claim 1, wherein the mineral powder is a natural mineral powder which may for example contain silicates.

6. The element according to claim 1, wherein the mineral powder is selected from the group including: clay, talc, pumice stone.

7. The element according to claim 1, wherein the mineral powder has a grain-size comprised between 5 and 200 μm, preferably between 20 and 100 μm, more preferably between 30 and 60 μm.

8. A system for cultivating at least one plant, comprising:
a tank including a bottom, a peripheral wall and an upper opening, said tank being intended to contain water;
a tray disposed at the level of the upper opening of the tank, including at least one aperture;
at least one mast supporting at least one light source;
at least one element according to claim 1;
at least one receptacle comprising a bottom and a peripheral wall, the receptacle receiving said element and being placed in the tank and received in an aperture of the tray.

9. A method for making an element intended to be placed in a receptacle for the cultivation of at least one plant, the element comprising a substantially solid body including a substrate adapted to enable said plant to develop, and at least one seed of said plant disposed on the body in a seed receiving area, the method comprising deposition of a holding composition on the seed(s) previously disposed on the body, in order to hold the seed(s) in said receiving area, and deposition of a holding composition which includes a mineral powder suspended in water.

10. The method according to claim 9, wherein the holding composition comprises from 15 to 25 weight %, for example in the range of 20 weight %, of clay having a grain-size comprised between 30 and 60 μm, for example in the range of 45 μm.

11. The method according to claim 9, further including the step of mixing of the holding composition prior to its deposition on the seed(s).

12. The method according to claim 9, wherein the holding composition further comprises at least one compound selected from: a fungicide, a germination promoting agent.

13. The method according to claim 9, wherein the receiving area comprises a recessed housing formed in the body and upwardly open, in the position of use of the element, the seed(s) being disposed at the bottom of the housing, and a holding composition is deposited in an amount sufficient to substantially fill the housing.

14. The method according to claim 10, further including the step of mixing of the holding composition prior to its deposition on the seed(s).

15. The method according to claim 14, wherein the holding composition further comprises at least one compound selected from: a fungicide, a germination promoting agent.

16. The method according to claim 15, wherein the receiving area comprises a recessed housing formed in the body and upwardly open, in the position of use of the element, the seed(s) being disposed at the bottom of the housing, and a holding composition is deposited in an amount sufficient to substantially fill the housing.

17. The element according to claim 2, wherein the receiving area comprises a recessed housing formed in the body and upwardly open, in the position of use of the element, the seed(s) being disposed at the bottom of the housing.

18. The element according to claim 17, wherein the holding layer at least partly covers the internal surface of the housing.

19. The element according to claim 18, wherein the mineral powder is a natural mineral powder which may for example contain silicates.

20. The element according to claim 19, wherein the mineral powder is selected from the group including: clay, talc, pumice stone.
